(19) United States
(12) Patent Application Publication
(10) Pub. No.: US 2011/0155820 A1
(43) Pub. Date: Jun. 30, 2011

(54) COMPOSITE STRUCTURE FOR RAILROAD TIES AND OTHER STRUCTURAL MEMBERS AND METHOD FOR THEIR MANUFACTURE

(76) Inventors: Torben Djerf, Grand Saline, TX (US); John D. Eisenhut, Canton, OH (US)

(21) Appl. No.: 12/649,921

(22) Filed: Dec. 30, 2009

(51) Int. Cl. E01B 3/10; E01B 3/36; B23P 25/00

(52) U.S. Cl. 238/85; 29/458

(57) ABSTRACT

A laminated and encapsulated railroad tie structure and its associated method of manufacture. A wood core of laminated wood slats is inserted into an extruded sleeve of scrap tire rubber and polyurethane. A urethane adhesive laminates the wood slats together and serves as a lubricant and bonding agent for placement and secured engagement of the sleeve about the core. End caps are securedly engaged at each end of the composite, being secured to both the wood core and sleeve. The bottom and side surfaces of the sleeve are characterized by longitudinal grooves or slots for engagement with a railroad bed.

### TECHNICAL FIELD

The present invention generally relates to composite structures, and in its preferred embodiments more specifically relates to a load bearing composite structure useful for railroad ties and other load bearing structural members.

### BACKGROUND ART

Railroad ties have traditionally been made of solid wood, typically hardwood that has been chemically treated with a preservative such as creosote to discourage insect attack and biological degradation. Treated solid wood ties, however, have a relatively short useful life span of five to fifteen years before they have deteriorated to the point that they must be replaced, and they often require significant maintenance during that life span. The use of spikes driven into the wood ties to secure the steel rails contributes significantly to the short life of such ties. The oscillating loads imparted to the rail spikes securing the rail gauge result in split ties and ejected spikes, both contributing to the need for early replacement or maintenance.

From an environmental perspective the use of solid wood ties is undesirable for several reasons, including the depletion of timber resources that could be put to better uses, and the use of toxic chemicals in the preservative treatment of the ties. Various alternatives to the use of solid wood railroad ties have been devised and are known in the prior art. Reinforced concrete ties are known in the art and are used in at least some rail applications. Concrete ties have a longer life span than wooden ties, but they are substantially more costly than wood. Concrete ties also require different installation techniques, since conventional spikes cannot be driven into concrete.

In another alternative approach, railroad ties are formed of recycled plastics and/or rubber materials using a process that involves heating the material of construction until melted, introducing the molten material into a mold, and allowing it to cool in the mold to produce a solid structure. Like concrete ties, these ties do have a longer life span than wooden ties, and have the environmental advantage of using recycled materials. The ties, and the methods of producing them known in the prior art, are not without disadvantages and drawbacks, however. One of the most significant problems with the ties themselves is that they do not securely retain spikes used to attach rails to the ties nearly as effectively as wooden ties. Although spikes can be driven into plastic ties, the low frictional cohesion between metal spikes and plastic ties causes driven spikes to loosen and slip, often immediately or very soon after installation, compromising the stability and integrity of the rails. As a result, plastic ties may require more maintenance than wooden ties to maintain the safety of the rail system. As a more effective alternative to spikes, lag screws or bolts may be used to secure the rails to the ties, but that approach requires costly replacement or modification of existing installation equipment.

The process of making solid ties from recycled plastics is slow and inefficient, because of the lengthy cooling time required and the fact that each tie must remain in the mold through the cooling period. Partly as a result of the inherently inefficient production process, and partly as a result of the large amount of material required for each tie, ties made of recycled plastics have been significantly more costly than wooden ties. Other approaches to making railroad ties are also known in the prior art. In one approach, a slightly smaller wooden tie is formed and coated with a protective material in an effort to retard degradation. In another approach, strips of automotive tire tread are layered and secured together. These and other alternative approaches do not appear to have been successful for a variety of reasons.

There remains a need for a railroad tie structure and a method of making the structure that is cost-effective, reduces the use of solid wood, utilizes recycled materials, resists degradation for an extended period of time, and can be installed using conventional spikes to form a secure and long lasting connection between rails and ties. The present invention provides such a structure and such a method of making railroad ties and other structural members suitable for a variety of uses.

### SUMMARY OF INVENTION

In light of the foregoing, it is a first aspect of the invention to provide a composite structure for railroad ties and the like that are configured to securely retain spikes or other fasteners used to attach the rails to the ties, and to resist aging and degradation for significantly longer periods of time than previously known structures.

Another aspect of the invention is the provision of a composite structure for railroad ties and the like, in which the structural element is maintained and sealed within a protective sleeve.

Yet another aspect of the invention is the provision of a composite structure for railroad ties and the like which is given to ease of manufacture using low cost materials for a core and recycled material for a protective sleeve.

Still a further aspect of the invention is the provision of a composite structure for railroad ties and the like in which the manufacturing method is sufficiently rapid to ensure cost effective throughput in operation.

The foregoing and other aspects of the invention that will become apparent as the detailed description proceeds are achieved by a composite tie assembly, comprising: a wood core; and an encasement about said wood core, said encasement being substantially impervious to degradation from ambient conditions.

Other aspects of the invention that will become apparent herein are achieved by a method for manufacturing a composite tie assembly, comprising: laminating a plurality of wood planks together to form a wood core; extruding a rectangular channel of a composite consisting primarily of scrap rubber and polyurethane; cutting said extruded channel into links adapted for receiving said wood core as a sleeve; driving said wood core into said cut length of sleeves; and attaching an end cap to each end of said wood core and sleeve.

### BRIEF DESCRIPTION OF THE DRAWINGS

These and other features and advantages of the present invention will become better understood with regard to the following description, appended claims, and accompanying drawings wherein:

FIG. 1 is a top view of a railroad tie made in accordance with the invention;

FIG. 2 is a bottom view of the railroad tie of FIG. 1;

FIG. 3 is a left end elevational view of the railroad tie of FIG. 1;

FIG. 4 is a right end elevational view of the railroad tie of FIG. 1;

FIG. 5 is an enlarged cross sectional view of the railroad tie of FIG. 1, taken along the line 5-5;

FIG. 6 is a perspective view of an end of the railroad tie during manufacture, before application of an end cap;

FIG. 7 is a perspective view of an end cap used with the railroad tie assembly;

FIG. 8 is a flow chart of the manufacturing process of the invention; and

FIG. 9 is a partial cross sectional view of a railroad tie in accordance with the invention, showing the securing of a gauge plate.

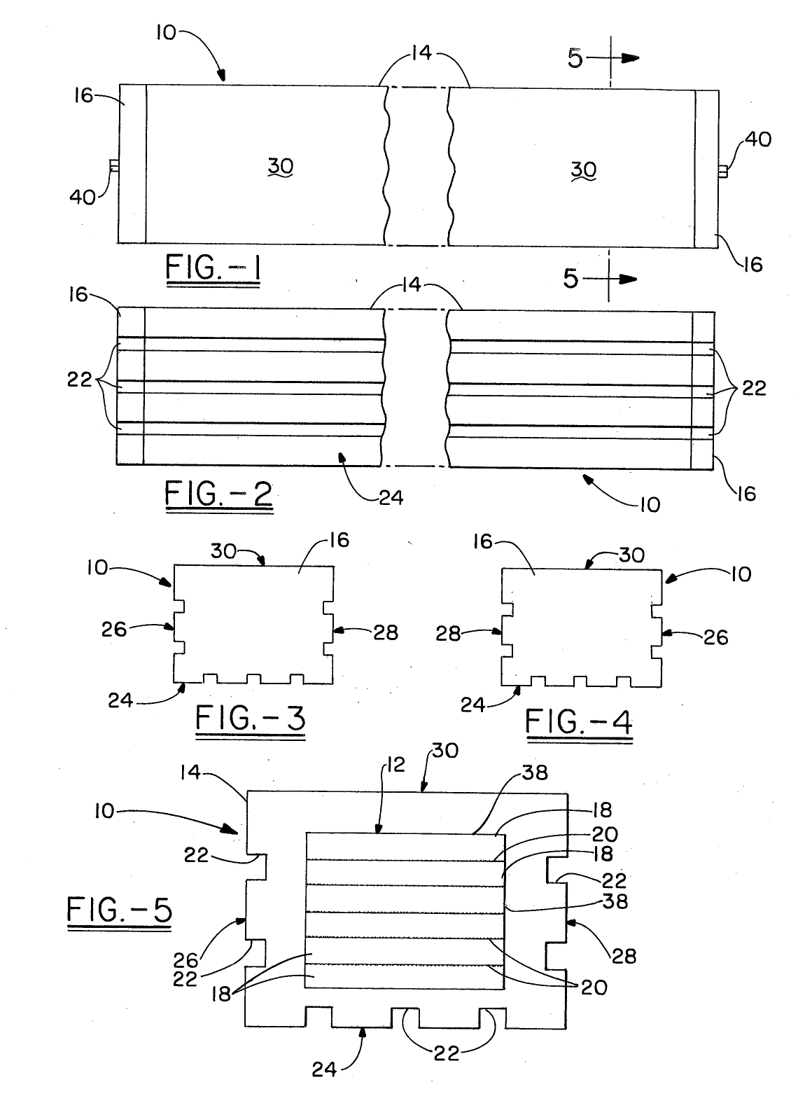

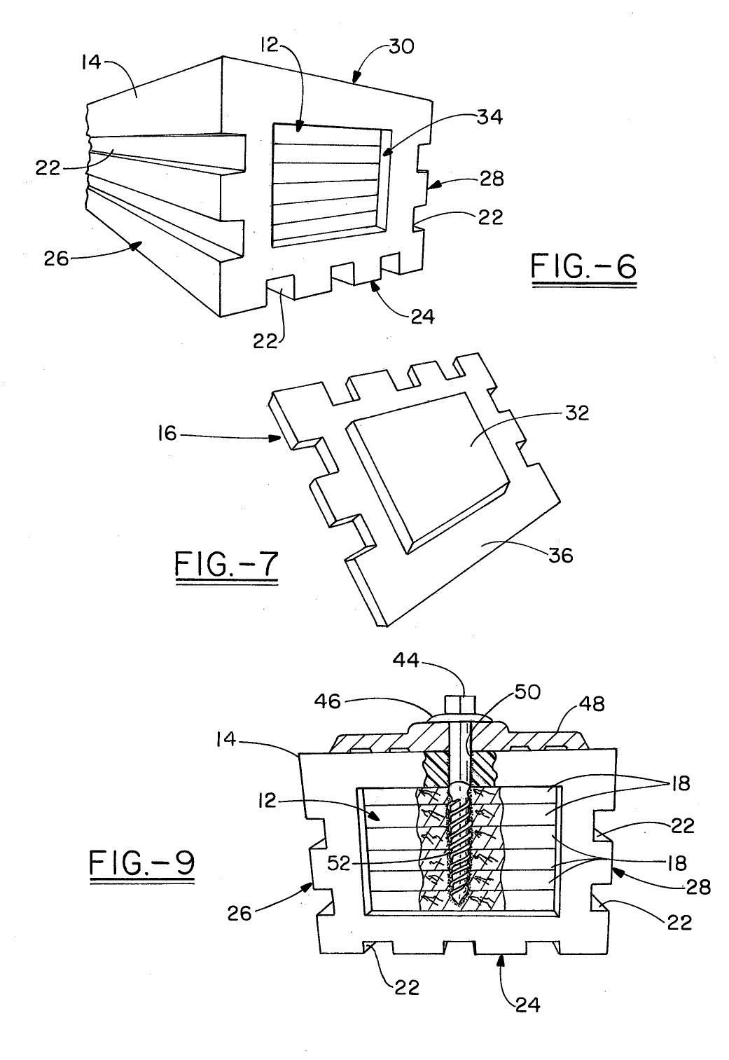

### BEST MODE FOR CARRYING OUT THE INVENTION

Referring now to the drawings, it can be seen that in the preferred embodiment the composite structural member of the invention, generally designated by reference number 10, includes a core 12, an outer layer 14, and end caps 16. The structural member of the invention is contemplated to be particularly useful for railroad ties, but the scope of the invention is not limited to use of the structure for that purpose, and encompasses any use to which the structure may prove to be suited.

Core 12 is preferably formed with a generally rectangular cross-sectional configuration, of a plurality of slats, planks or boards 18. Slats 18 are layered or stacked, with each slat in the interior of the stack in face to face contact with adjacent slats, and with their side edges and ends aligned. The slats are secured together with a suitable adhesive material 20 applied between each slat. In the preferred method of the invention, the selected number of slats used to make each core 12 are successively placed in a press with a fast curing adhesive 20 between them. The layered slats are then pressed together in the press for the short time necessary for the adhesive to achieve a sufficient degree of cure to bond the slats 18 together and allow them to be removed from the press. Full curing of the adhesive 20 is completed outside the press, minimizing the hold time in the press and increasing the production rate of the core components of the composite structure. Mechanical fasteners such as screws or the like may be used in addition to the adhesive, if desired, but a sufficiently strong bond can be achieved with adhesive alone to render the use of mechanical fasteners unnecessary. According to a preferred embodiment of the invention, a urethane adhesive capable of rapid electron beam curing, such as that currently sold under the mark “Gorilla Glue,” is quite suitable.

It is preferred that the width of each slat, from edge to edge, be equal to the width of the completed core. It is also preferred that the length of each slat be equal to the length of the completed core. However, slats of shorter length or width may be used within the scope of the invention, with two or more slats butted together end to end or side by side in each layer of slats forming the completed core. If shorter or narrower slats are used, the butt joints between slats in different layers are preferably staggered to maximize the structural integrity of the core.

After the core 12 is formed, it is preferably impregnated with a plastic material, preferably an acrylic plastic, by placing the core in a bath of uncured plastic resin and subjecting the core and resin to pressure so as to increase the penetration of the resin into the core material. After pressure treatment for a sufficient period of time to achieve the desired degree of penetration, the core is removed from the bath and the resin is allowed to fully cure. Full penetration of the plastic material into the core is not necessary to achieve the benefits of impregnation, which include strengthening the core material and improving its ability to resist splitting when fasteners such as railroad spikes are driven into the core, sealing the core against the entry of moisture for the purpose of resisting decay, and sealing the core against the entry of or attack by wood eating insects such as termites.

Outer layer 14 comprises a hollow, open ended body with a continuous side wall about and encasing the core 12. If the structural member of the invention is to be used as a railroad tie, longitudinal grooves or slots 22 are preferably formed in lower face 24 and side faces 26 and 28 of the encasing outer layer 14. Such longitudinal grooves or slots facilitate engagement between the structural member and the granular material (gravel) commonly used in railroad construction as a bedding material. Grooves or slots 22 are preferably omitted from upper face 30 so as to provide a smooth upper face for the placement and connection of rails and gauge plates.

In the preferred embodiment, the cross-sectional configuration of the outer layer matches the cross-sectional configuration of core 12, and the inside cross-sectional dimensions of outer layer 14 are approximately equal to the outside cross-sectional dimensions of core 12. The length of outer layer 14 differs from that of core 12, to accommodate end caps 16 as described below.

Outer layer 14 is preferably formed of materials derived from recycled tires, from which at least the majority of the steel or other metal in the material has been removed. The preferred material of construction includes rubber and non-metallic textile materials from the tires, which have been shredded to particle sizes suitable for handling and for the production process described below. Plastic materials, preferably recycled, may be added to the tire materials, to aid in binding the materials and to modify the characteristics of the tire materials as appropriate to the use for which the structural member is intended.

The outer layer 14 is preferably formed by an extrusion process, in which the recycled tire materials, and additive materials if used, are heated to melt the rubber (and plastic materials if used) and achieve a viscosity suitable for blending and melding the materials and for conveying the melted materials to and through an extrusion die. The heated, blended materials are forced through an extrusion die to form the elongate hollow profile of the outer layer in a continuous flow from the die. The extruded body is immediately cooled to maintain the desired profile, or cross-sectional configuration, and the extruded body is cut at appropriate intervals to produce the outer layers for the composite structural members of the invention.

During the extrusion process, various means for maintaining the cross-sectional profile and dimensions of the extruded body may be employed if needed. As a non-limiting example, the extruded body may be received in a slip form immediately after existing the extrusion die, to maintain the extruded profile until the body has cooled sufficiently to “set” the configuration. The slip form may be cooled, if desired, to enhance heat transfer and reduce that initial cooling period. As another example, the extruded body may be passed through a vacuum chamber, in which a vacuum imposed around the hollow body to create a pressure differential between the interior and exterior of the body and prevent the body from deforming before it has cooled sufficiently to maintain its shape.

The extrusion of outer layer 14 as a hollow body substantially reduces the cooling or setting time in comparison to methods of making composite structural members known in the prior art. In prior art methods, structural members are commonly cast as solid bodies in a mold, or a layer of covering material is formed around a core. In both approaches, a lengthy cooling or setting time is required before the bodies can be removed from the mold in which they are formed. Forming the outer layer as an open, hollow body in accordance with the invention eliminates that problem and enables a significantly increased production rate.

According to one embodiment, end caps 16 are configured and dimensioned to be received partially in, and across, the open ends of outer layer 14. Each end cap 16 includes an extension 32, configured and dimensioned to be received in the open ends 34 of the outer layer 14, and a closure cap 36, configured and dimensioned to match the outside configuration and dimensions of the outer layer 14, to be received against the ends of such outer layer. In the preferred embodiment, end caps 16 are formed of the same materials as outer layer 14, and the end caps are preferably formed by molding or casting. Because the volume of material in each end cap is relatively small, the cooling or setting time required before the formed end caps can be removed from molds is acceptably short.

In an alternate embodiment of the invention, the core 12 may extend beyond the outer layer or sleeve 14 and the extension 32 of end cap 16 may be replaced with a recess configured to receive the end of the core 12 extending from the outer layer 14.

After formation of core 12, outer layer 14, and end caps 16, the structural member 10 of the invention is formed by inserting a core 12 into the hollow interior of an outer layer body or sleeve 14, and attaching an end cap 16 to each end of the core and outer layer. In the preferred method, an adhesive material compatible with the core material and the outer layer material is applied to the core, and/or to the interior of the outer layer. Suitable adhesive materials, such as urethane adhesives, have a low coefficient of friction in an uncured state, so that the adhesive material acts as a lubricant to facilitate insertion of the core into the interior of the outer layer, or vice versa, and to prevent deformation of the outer layer during the insertion process. According to a preferred process, a hydraulic ram press may be employed for such purpose. After the core and the outer layer are joined, the adhesive is allowed to cure, as by electron beam or other curing process, forming a strong adhesive bond 38 between the core 12 and the outer layer 14. The end caps 16 may be connected to each end of the composite structure at any appropriate time after the core and the outer layer are joined. Connection of the end caps may be delayed to allow time for the volatile solvents used in the adhesive formulation to evaporate through the open ends of the structure, or, if time need not be allowed for solvent evaporation, the end caps 16 may be connected immediately after the core 12 and outer layer or sleeve 14 are joined. The end caps are preferably secured with an adhesive, such as a urethane adhesive, and mechanical fasteners such as lag screws may be used in addition. It is preferred that an adhesive be used, either alone or in conjunction with mechanical fasteners or lag screws, to seal the joints between the end caps 16 and the rest of the structure. It has been found that a single lag screw 40 through the center of the end cap 16 and into the end of wood core 12 is sufficient to retain the cap while the adhesive cures.

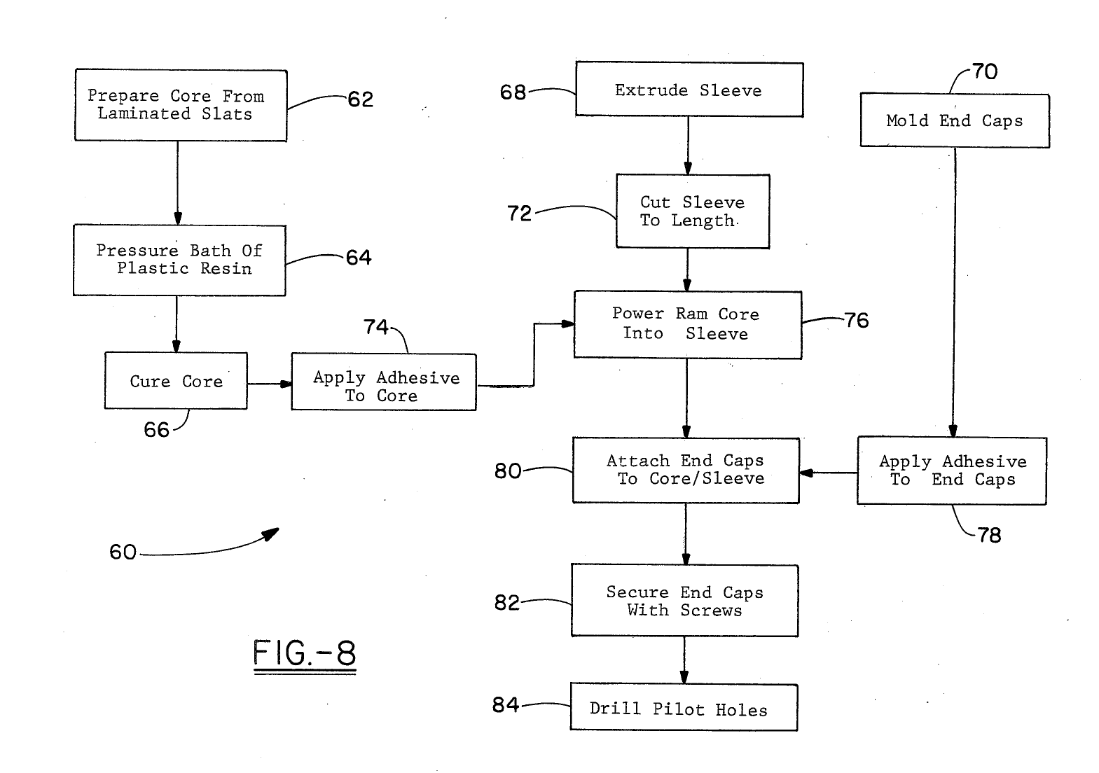

With reference now to FIG. 8, it can be seen that the manufacturing and process just described is shown in flow chart form and designated generally by the numeral 60. As shown, the core 10 is prepared by adhesively laminating wood slats at 62. In a preferred embodiment of the invention, the laminated core may then be subjected to a pressure bath of plastic resin as at 64, and thereafter the core 66 may be allowed to cure—typically for a matter of minutes. While the cores are being prepared at 62, the sleeve or outer layer is being extruded from a blend of scrap tire rubber and the like at 68, and the end caps are being molded of similar material at 70. As the sleeve is extruded at 68, it is cut to length at 72 and, as presented above, while still warm the process of inserting the wood core into the sleeve is undertaken. In this process, an adhesive is supplied to the core at 74, the adhesive serving as a lubricant for the core as a power ram or other appropriate device is used to drive or draw the core into the sleeve as at 76. At 78, an adhesive is applied to the inner surfaces of the end caps, which are then attached to the combination core/sleeve at 80. If desired, the end caps may be secured by a single lag screw at 82 to ensure retention of the end caps while the adhesive cures. Subsequently, and if desired, either during manufacture or on the job site, pilot holes may be driven through the outer layer or sleeve and into the wood core as at 84 for receipt of an adhesive (if desired) and a retaining screw for a gauge plate, as will be discussed directly below.

The core 12 of the composite structure of the invention is rigid, providing strength and stability to the structure, and the outer layer 14 is resilient, providing cushioning and shock absorbency to the structure. When a railroad spike or other fastener is driven through the outer layer 14 and into the core 12, the core will retain its integrity without splitting, and will securely anchor the spike in the structure, and the resilient outer layer 14 will tend to seal around the spike. As shown in FIG. 9, the spike or retaining screw 44 is driven orthogonal to the planes of facial contact between adjacent planks or slats 18 of the laminated wood core 12 and, in combination with the spike or screw head 44 and washer or retainer 46, secures a gauge plate 48 to the tie 10.

For added integrity of the interengagement of the spike or retaining screw 44 with the tie 10, it is contemplated that a pilot hole 50 may be drilled through the outer layer or sleeve 14 and into the wood core 12. Prior to receipt of the spike or retaining screw 44, the pilot hole is filled with an adhesive such as a urethane adhesive 52, enhancing the mechanical bond with the wood core 12 and the sealing engagement with the outer layer 14.

The sealing effect provided by the resilient outer layer not only helps anchor the spike, but also prevents the entry of water and insects into the interior of the structure, substantially curtailing deterioration and extending the useful life of the structural member in comparison to conventional materials. The ability of the resilient outer layer to seal around a penetration, as well as the protection of the core material provided by plastic impregnation, makes the composite structural members of the invention very well suited for use in a marine environment. The structural members of the invention not only resist the ingress of water through penetrations, but also resist deterioration by any water that does find its way into the interior of the structure.

The scope of the invention is not limited to the specific structure and materials of, especially, the core component of the structure described above in reference to the preferred embodiment, and the structure is susceptible to a variety of alternative embodiments and variations. One of the objectives of the invention is to utilize recovered or recycled materials, and especially those that are presently under-utilized and are often disposed in landfills. As an alternative to the use of boards, planks or slats to form the core of the structure, the core may be formed of wood chips or scrap that are consolidated, compressed, and impregnated generally as described. It is contemplated that the core may be effectively formed from processed municipal waste materials, with a high cellulose content, such as wood and paper scraps. Similarly, the outer layer may be formed of alternative materials that will provide the desired characteristics for construction of the composite structure and in use.

In the foregoing the core is described as extending through essentially the full length of the composite structural member, but the invention encompasses other structures as well. For example, shorter core structures may be used, and a core component disposed at each end of the structure and the space between them either left open or filled with another material. Such a structure is suited for use as a railroad tie, for example, since the rails are laid across and connected to the ties adjacent to each end. Other arrangements of structural core(s), with or without intermediate filler material may be devised for particular needs and uses.

What is claimed is:

1. A composite tie assembly, comprising:
a wood core; and
an encasement about said wood core, said encasement being substantially impervious to degradation from ambient conditions.

2. The composite tie assembly according to claim 1, wherein said wood core comprises a laminate construction of a plurality of wood planks.

3. The composite tie assembly according to claim 2, wherein said wood planks are laminated together with an adhesive.

4. The composite tie assembly according to claim 3, wherein said adhesive comprises a urethane adhesive.

5. The composite tie assembly according to claim 3, wherein said wood planks are substantially the same width and length.

6. The composite tie assembly according to claim 3, wherein said encasement comprises a composition primarily of scrap rubber and polyurethane.

7. The composite tie assembly according to claim 6, wherein said encasement comprises a sleeve having an interior with a cross section substantially congruent with a cross section of said wood core, and a length differing from that of said wood core.

8. The composite tie assembly according to claim 7, wherein said encasement comprises a pair of end caps, one at each end of said sleeve, each said end cap having a center section taken from the group of a protrusion and recession for respectively being received by said sleeve and receiving an end of said wood core.

9. The composite tie assembly according to claim 8, wherein said end cap is secrured to said wood core by a screw.

10. The composite tie assembly according to claim 9, wherein said end cap is secured to said sleeve, and said end caps are secured to said sleeve by an adhesive.

11. The composite tie assembly according to claim 10, wherein said sleeve is characterized by a plurality of slots extending longitudinally along three sides thereof, and wherein said caps are characterized by correspondingly aligned slots.

12. The composite tie assembly according to claim 11, further characterized by a pilot hole through a top surface of said sleeve and into said wood core, said pilot hole receiving a urethane adhesive and a screw, said screw securing a gauge plate.

13. A method for manufacturing a composite tie assembly, comprising:
laminating a plurality of wood planks together to form a wood core;
extruding a rectangular channel of a composite consisting primarily of scrap rubber and polyurethane;
cutting said extruded channel into lengths adapted for receiving said wood core as a sleeve;
driving said wood core into said cut length of sleeve; and
attaching an end cap to each end of said wood core and sleeve.

14. The method for manufacturing a composite tie assembly according to claim 13, further comprising the step of coating said wood core with a urethane adhesive prior to driving said wood core into said cut length of sleeve.

15. The method for manufacturing a composite tie assembly according to claim 14, wherein said wood core is driven into said cut length of sleeve, while said cut length of sleeve is of an elevated temperature from said extruding step.

16. The method for manufacturing a composite tie assembly according to claim 15, wherein said end cap receives an end of said wood core extending beyond said cut length of sleeve.

17. The method for manufacturing a composite tie assembly according to claim 15, wherein said end cap is received by a recess formed between ends of said wood core and cut length of sleeve.

18. The method for manufacturing a composite tie assembly according to claim 17, wherein said end cap is secured to said ends of said wood core and cut length of sleeve by an adhesive and a screw passing through said end cap and into said wood core.

19. The method for manufacturing a composite tie assembly according to claim 18, further comprising the step of introducing a pilot hole through a top of said cut length of sleeve and into said wood core, depositing a urethane adhesive into said pilot hole, and securing a gauge plate by a screw passing into said pilot hole.

20. The method for manufacturing a composite tie assembly according to claim 13, wherein said extruding step forms slots along opposite side surfaces and a bottom surface of said extruded channel and forms a smooth top surface.
